(19) United States
(12) Patent Application Publication
(10) Pub. No.: US 2016/0164361 A1
(43) Pub. Date: Jun. 9, 2016

(54) LARGE OUTPUT, HIGH EFFICIENCY, SINGLE PHASE, MULTI-POLAR POWER GENERATOR

(71) Applicant: Hisayoshi FUKUYANAGI, Tokyo (JP)

(72) Inventor: Hisayoshi Fukuyanagi, Tokyo (JP)

(21) Appl. No.: 14/903,145

(22) PCT Filed: Jul. 9, 2014
(86) PCT No.: PCT/JP2014/068274

§ 371 Date: Jan. 6, 2016

(30) Foreign Application Priority Data
Jul. 9, 2013 (JP) 2013-143793

(51) Int. Cl. H02K 3/28; H02K 11/33; H02K 1/27

(52) U.S. Cl. CPC H02K 3/28; H02K 1/2753; H02K 11/33

(57) ABSTRACT

Provided is a large output, high efficiency, single phase, multi-polar power generator, the output of which can be increased and the material of which can be reduced in amount, with a simple structure. The power generator has a rotor having m or 2·m (m: an even integer not smaller than 2) magnetic pole portions arranged so as to alternately have different polarities in a circumferential direction, and a stator having m·n (n: 3 or 4) teeth-projecting in such a direction as to be opposed to the rotor, the teeth being formed at equal spaces in a circumferential direction. The stator has m stator coils wound around the teeth at equal intervals in a circumferential direction. Each of the stator coils is wound around adjacent n−1 ones of the teeth. With this structure, the output of the power generator is increased and the material thereof is reduced in amount.

### TECHNICAL FIELD

The present invention relates to a large output, high efficiency, single phase, multi-polar power generator having a rotor including magnetic poles, and a stator including stator coils and, more particularly, to an improvement in the structure of the power generator.

### BACKGROUND ART

A power generator having a rotor fixed to an input shaft and a stator disposed by being spaced apart from the rotor is known. The rotor has magnetic poles formed by magnets disposed so as to alternately have different polarities in the circumferential direction of the rotor. Meanwhile, the stator has teeth projectingly formed so as to be opposed to the magnets of the rotor and stator coils wound around the teeth. In the power generator thus constructed, voltages are induced in the stator coils by electromagnetic induction acting between the stator coils and rotating magnetic fields generated by the rotation of the rotor, which causes electric currents to flow and generates electric power.

In a case where electric power generated by a power generator is multiphase alternating currents, the stator coils for the different phases are generally disposed at equal intervals in sequence in the circumferential direction. Electromotive forces of the same magnitude are generated from the stator coils, and the power of multiphase alternating currents with uniformly distributed phases is extracted. For example, in the case of a three-phase alternating current power generator, the power of three-phase alternating currents having a phase difference of 120° among them is extracted. In the case of a five-phase alternating current power generator, the power of five-phase alternating currents having a phase difference of 72° among them is extracted.

Patent Document 1 shown below discloses a rotating electric motor having a rotor in which a plurality of holding holes extending along the axial direction are formed at equal intervals in the circumferential direction and magnets are respectively disposed in the holes.

Patent Document 2 shown below discloses a three-phase alternating current power generator having a cylindrical rotor having permanent magnets disposed on its inner periphery and a stator provided by being spaced apart from the inner periphery of the rotor. The stator has teeth provided so as to project radially outwardly and stator coils wound around the teeth. In this power generator, electric power is generated by electromagnetic induction between the permanent magnets and the stator coils caused by the rotation of the rotor.

### CITATION LIST

### Patent Literature

### Patent Document 1: Japanese Patent Laid-Open No. 2000-228838

### Patent Document 2: Japanese Patent Laid-Open No. 2004-166381

In the conventional three-phase alternating current power generator, as described above, the stator coils are disposed so that the power of three-phase alternating currents can be extracted such that the magnitudes of electromotive forces produced with different phases are equal to each other and the difference between the phases is 120°. With such an arrangement, the power of three-phase alternating currents can be generated by rotating the rotor in a high speed rotation range; for example, at 1600, 2000, 3500, or 4000 rpm so that output characteristic requirements of the power generator are met. However, when the rotor is rotated in a high speed rotation range such as described above, heat generation is necessarily increased and there is a possibility of damage to the power generator or shortening of the life of the power generator.

Inhibiting heat generation such as described above by only increasing the number of stator coils and rotating the rotor in a low speed rotation range; for example, at 1000 rpm or less, is conceivable. The arrangement of the conventional three-phase alternating current power generator, however, has a problem that the magnetic resistance of the stator coils is increased and, therefore, the rotor cannot be rotated or cannot reach the desired rotational speed, resulting in failure to obtain the desired output electric power.

An object of the present invention is to provide a large output, highly efficient power generator that is simple in structure and capable of being designed to increase the output and to reduce the amount of conductor material used for stator coils.

### SUMMARY OF INVENTION

According to the present invention, there is provided a large output, high efficiency, single phase, multi-polar power generator including a rotor having m or 2·m (m: an even integer not smaller than 2) magnetic pole portions arranged so as to alternately have different polarities in a circumferential direction, a stator having m·n (n: 3 or 4) teeth projecting in such a direction as to be opposed to the rotor, the teeth being formed at equal spaces in a circumferential direction, wherein the stator has m stator coils wound around the teeth at equal spaces in a circumferential direction, and wherein each of the stator coils is wound around adjacent n−1 ones of the teeth.

Preferably, each magnetic pole portion is formed of a plurality of magnetic poles with the same polarity.

Preferably, a circuit for generated power output from the stator coils is formed of a voltage summation circuit formed by series connection to obtain the sum of voltages or a current summation circuit formed by parallel connection to obtain the sum of currents.

Preferably, a circuit for generated power output from the stator coils is formed of a combination of a voltage summation circuit formed by series connection to obtain the sum of voltages and a current summation circuit formed by parallel connection to obtain the sum of currents.

The teeth around which the stator coil is wound can be formed into one integral body.

The large output, high efficiency, single phase, multi-polar power generator according to the present invention is simple in structure and capable of increasing the output and reducing the amount of conductor material used for the stator coils.

### BRIEF DESCRIPTION OF DRAWINGS

FIG. 1 is a diagram showing the arrangement of a large output, high efficiency, single phase, multi-polar power generator according to an embodiment of the present invention.

FIG. 2 is a diagram showing a disposition of stator coils.

FIG. 3 is a diagram showing an example of a generated power output circuit.

FIG. 4 is a diagram showing another example of the generated power output circuit.

FIG. 5 is a diagram showing the arrangement of a large output, high efficiency, single phase, multi-polar power generator according to another embodiment.

FIG. 6 is a diagram showing the arrangement of a large output, high efficiency, single phase, multi-polar power generator according to still another embodiment.

FIG. 7 is a diagram showing the arrangement of a large output, high efficiency, single phase, multi-polar power generator according to a further embodiment.

FIG. 8 is an exploded perspective view of a rotor having an electromagnet.

FIG. 9 is a perspective view of the rotor having an electromagnet.

FIG. 10 is a diagram showing examples of the shape of distal end portions of pole cores.

FIG. 11 is a diagram showing an aspect of teeth around which a stator coil is wound.

### DESCRIPTION OF EMBODIMENTS

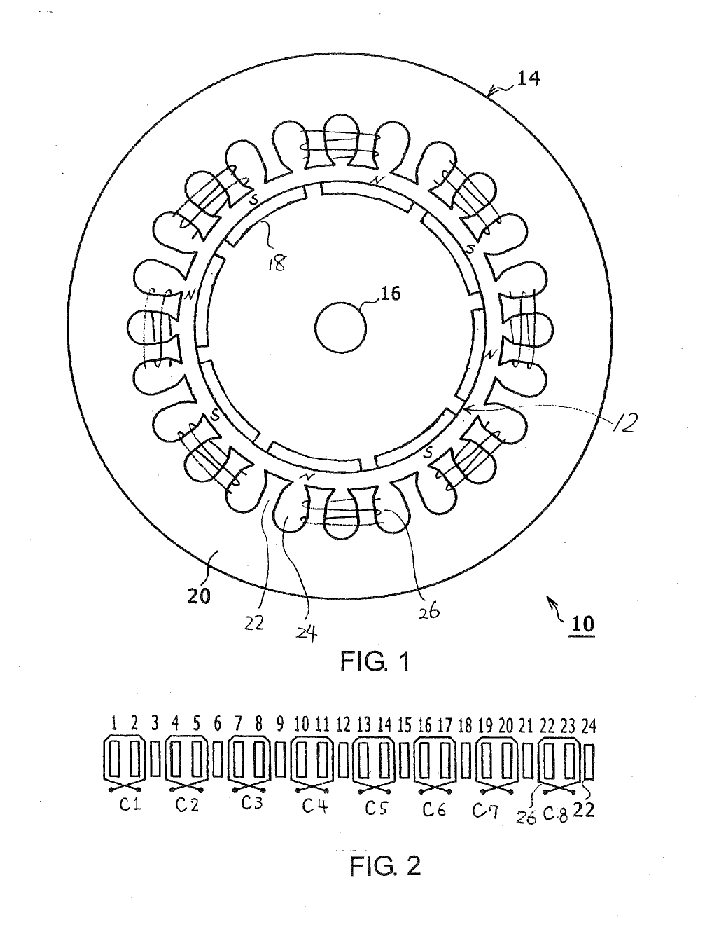

An embodiment of a large output, high efficiency, single phase, multi-polar power generator according to the present invention will be described below with reference to the drawings. FIG. 1 is a diagram showing the arrangement of a large output, high efficiency, single phase, multi-polar power generator according to the present embodiment. FIG. 2 is a diagram showing the disposition of stator coils.

A large output, high efficiency, single phase, multi-polar power generator (hereinafter referred to simply as “power generator”) 10 according to the present invention is a power generator which generates the power of a single-phase alternating current from each of a plurality of stator coils. The power generator 10 has a rotor 12 and a stator 14. The rotor 12 is rotatably disposed by being spaced apart from the inner periphery of the stator 14.

The rotor 12 is a cylindrical member made of a magnetic material and concentric with an input shaft 16. For example, the rotor 12 is constructed by stacking electromagnetic steel plates in its axial direction. The rotor 12 is fixed to the input shaft 16 to be integrally rotatable with the input shaft 16. The rotor 12 has eight magnetic pole portions 18 arranged in its circumferential direction. The magnetic pole portions 18 in the present embodiment are permanent magnets 19. Eight permanent magnets 19 are disposed at equal spaces so that N-poles and S-poles are alternately provided in the circumferential direction of the rotor 12. The above-mentioned number of magnetic pole portions 18 is only an example. The number of magnetic pole portions 18 may be m (m: an even integer not smaller than 2).

In the present embodiment, each of the permanent magnets 19 provided as magnetic pole portions 18 is disposed in the peripheral surface of the rotor 12 along the axial direction. The present invention, however, is not limited to this arrangement. The permanent magnets 19 may be disposed by being embedded in holes formed in the rotor 12 so as to extend in the axial direction. While the present embodiment has been described with respect to a case where the rotor 12 is constructed by stacking electromagnetic steel plates, the present invention is not limited to this arrangement. The rotor 12 may be formed of a compacted-powder magnetic core, so long as it is made of a magnetic material.

The stator 14 is disposed around the rotor 12 with a small spacing from the rotor 12. The stator 14 is a cylindrical member made of a magnetic material and concentric with the input shaft 16. For example, the stator 14 is constructed by stacking electromagnetic steel plates in the axial direction. More specifically, the stator 14 is formed by punching an electromagnetic steel plate in the form of a sheet with a press, stacking a predetermined number of the punched electromagnetic steel plates in the axial direction, and connecting the stacked plural electromagnetic steel plates by working such as press caulking.

While the present embodiment has been described with respect to a case where the stator 14 is constructed by stacking electromagnetic steel plates, the present invention is not limited to this arrangement. The stator 14 may be formed of a compacted-powder magnetic core, so long as it is made of a magnetic material.

The stator 14 has an annular yoke 20 and teeth 22 projecting radially inwardly from the inner periphery of the yoke 20 and disposed at predetermined intervals in the circumferential direction. In the present embodiment, twenty-four teeth 22 are disposed at equal intervals in the circumferential direction, as shown in FIG. 1. This number of teeth 22 is only an example. The number of teeth 22 may be set to 3·m.

A slot 24, which is a space in channel form, is formed between each adjacent pair of the teeth 22. A conductor is wound around the teeth 22 while being passed through the slots 24 to form stator coils 26.

In the power generator 10 thus constructed, voltages are induced in the stator coils 26 by electromagnetic induction acting between the stator coils 26 and rotating magnetic fields generated by the rotation of the rotor 12, thus generating electric power.

The power generator 10 according to the present embodiment is characterized in that the stator 14 has the same number of stator coils 26 disposed at equal spaces in the circumferential direction as the number of magnetic pole portions 18, and that each stator coil 26 is wound around two adjacent teeth 22.

The same number of stator coils 26 as the number of magnetic pole portions 18 are disposed at equal spaces in the circumferential direction, as described above, thereby generating the electric power of a single-phase alternating current. Also, each stator coil 26 is wound around two adjacent teeth 22, thereby limiting increase in reaction against the rotating rotor 12; i.e., reverse torque against the magnetic pole portions 18 in comparison with a generator in which stator coils are disposed so that the power of three-phase alternating currents can be extracted. Therefore, the rotational speed of the rotor 12 can easily be increased to thereby increase the output.

In the conventional three-phase alternating current generator, for example, the stator coils for each phase are wound around ones of the teeth between which the other ones of the teeth for the other two phases exist, the stator coils being disposed so that the phase differences between the phases are uniformly set to 120°. In the power generator 10 according to the present invention, the stator 14 capable of disposing stator coils so that the power of three-phase alternating currents can be extracted is adopted, but the stator coils 26 are disposed so that no phase difference or a phase difference of 180° is set between the stator coils 26. Such an arrangement enables single-phase disposition of the stator coils 26. Since the number of stator coils 26 in the present embodiment is reduced in comparison with the stator coil disposition for three-phase alternating currents, increase in reaction against the rotating rotor 12; i.e., reverse torque against the magnetic pole portions 18, is limited, thus facilitating an increase in the rotational speed of the rotor 12.

The number of stator coils 26 wound around the teeth 22, which is eight, is smaller than the number of teeth 22, which is twenty four, as shown in FIGS. 1 and 2. Also, the stator coils 26 are disposed by being continuously wound around adjacent pairs of the teeth 22, and one of the teeth 22 around which no coil is wound is provided between each adjacent pair of the stator coils 26. With this arrangement, increase in reverse torque against the magnetic pole portions 18 is further limited to thereby enable an increase in the rotational speed of the rotor 12. It has been found that the power generator 10 according to the present embodiment is capable of obtaining an increased output in comparison with the three-phase alternating current power generator having stator coils for three-phase alternating currents (distributed windings or concentrated windings) disposed on all the twenty-four teeth 22. Also, the power generator 10 according to the present embodiment is capable of obtaining an increased output in comparison with a single-phase alternating current power generator having eight teeth and stator coils simply disposed uniformly in the circumferential direction.

A circuit for generated power output from the stator coils 26 in the present embodiment is a voltage summation circuit formed by series connection to thereby obtain the sum of voltages or a current summation circuit formed by parallel connection to thereby obtain the sum of currents. The desired voltage and current output can be obtained by forming such a voltage summation circuit or a current summation circuit as a generated power output circuit. The desired voltage and current outputs can also be obtained with a generated power output circuit constituted by a combination of a voltage summation circuit and a current summation circuit.

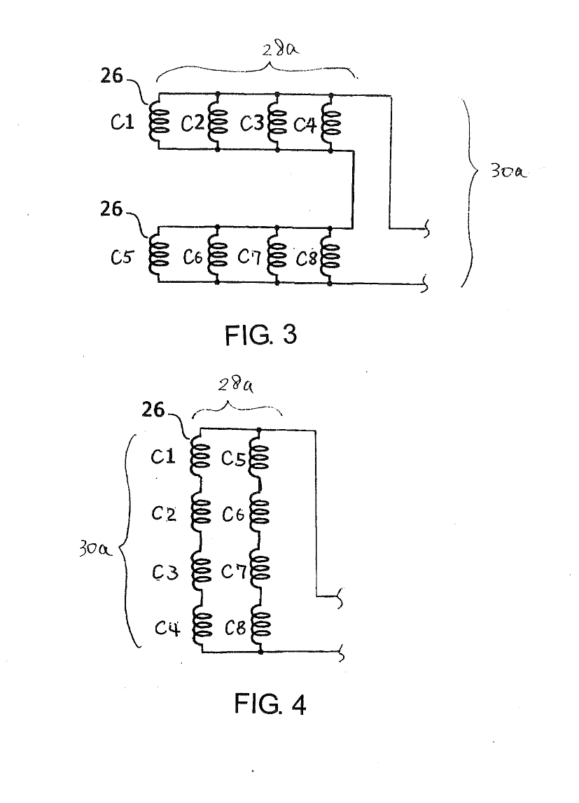

Generated power output circuits for the power generator 10 will be described with reference to FIGS. 3 and 4. A generated power output circuit shown in FIG. 3 will first be described. The generated power output circuit has a configuration in which output terminals of coils C1, C2, C3, and C4 are connected in parallel with each other; output terminals of coils C5, C6, C7, and C8 are connected in parallel with each other; and the two parallel connection circuits thereby formed are connected in series with each other. The output terminals of certain ones of the coils are connected in parallel with each other, thereby enabling summing of the currents of generated power. A current summation circuit 28a is formed by making such parallel connection. The two current summation circuits 28a are connected in series with each other, thereby enabling summing of the voltages of generated power. A voltage summation circuit 30a is formed by making such series connection. A generated power output circuit is arranged in this way to enable output of generated power by increasing the current and increasing the voltage comparatively largely.

A generated power output circuit shown in FIG. 4 is also an example of a combination of the current summation circuit 28a and the voltage summation circuit 30a. That is, the generated power output circuit has a configuration in which the output terminals of the coils C1, C2, C3, and C4 are connected in series with each other; the output terminals of the coils C5, C6, C7, and C8 are connected in series with each other; and the two voltage summation circuits 30a thereby formed are connected in parallel with each other. A generated power output circuit is arranged in this way to enable output of generated power by increasing the voltage comparatively largely and increasing the current.

In a case where all the stator coils 26 are wound around the teeth 22 in the same direction, voltage waveforms output from the coils C1, C3, C5, and C7 are identical with each other while voltage waveforms output from the coils C2, C4, C6, and C8 are shifted by 180° relative to the waveforms from the coils C1, C3, C5, and C7. It is, therefore, necessary to connect the output terminals of the coils C2, C4, C6, and C8 by inverting these terminals in the current summation circuit 28 and the voltage summation circuit 30 so that the voltage waveforms from the coils C2, C4, C6, and C8 become the same as those from the coils C1, C3, C5, and C7. On the other hand, in a case where the direction of winding of the coils C2, C4, C6, and C8 is reversed, the voltage waveforms output from the coils C1 to C8 are identical with each other and, therefore, the output terminals of the coils C1 to C8 can be connected in the same order in the current summation circuit 28 and the voltage summation circuit 30.

The generated power output circuits shown in FIGS. 3 and 4 have been described with respect to a case where the stator coils 26 are arranged in coil numbering order. The present invention, however, is not limited to this. It is not necessarily required that the output terminals of the stator coils 26 be connected in coil numbering order.

The embodiment shown in FIG. 1 has been described with respect to a case where one magnetic pole portion 18 is one permanent magnet 19, and permanent magnets 19 are disposed at equal spaces so that N-poles and S-poles are alternately provided in the circumferential direction. The present invention, however, is not limited to this arrangement. One magnetic pole portion 18 may be formed of a pair of magnets with the same polarity, and the magnets forming magnetic pole portions 18 may be arranged by being spaced apart one from another in the circumferential direction.

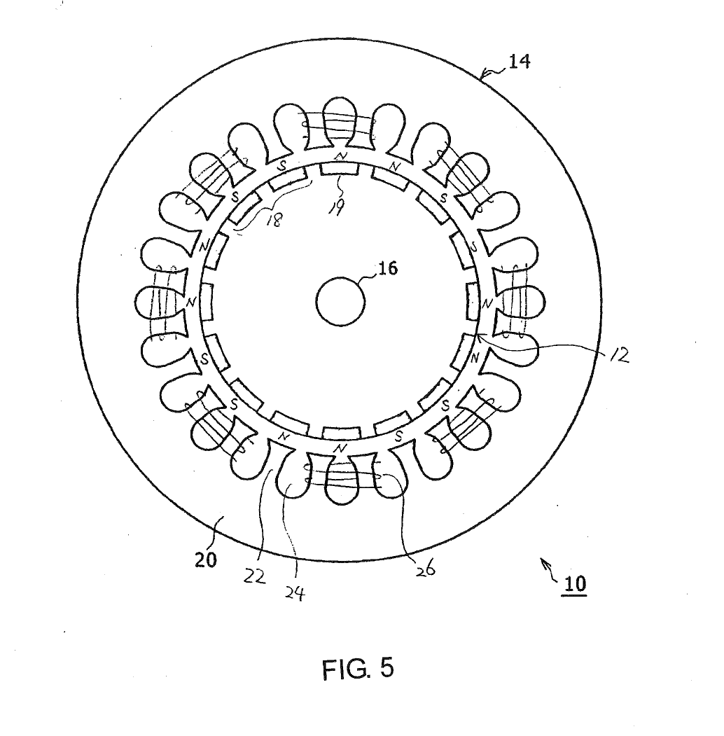

FIG. 5 is a diagram showing the arrangement of a power generator 10 according to another embodiment. In the rotor 12 in this aspect, the magnetic pole portions 18 are arranged so as to alternately have different polarities in the circumferential direction, as are those shown in FIG. 1. Each magnetic pole portion 18 is formed of a pair of permanent magnets 19 with the same polarity. Accordingly, in the rotor 12, sixteen permanent magnets 19 are arranged in order of N, N, S, S, N, N, S, S . . . . This arrangement has the effect of making the waveform of the magnetic flux across each stator coil 26 gentler in the vicinity of its peak value and larger in width as a whole. As a result, the reaction against the rotating rotor 12 can be reduced and an increased output can be obtained in comparison with the power generator using the rotor 12 shown in FIG. 1. This embodiment has been described with respect to a case where each magnetic pole portion 18 is formed of a pair of magnets with the same polarity. The present invention, however, is not limited to this arrangement. The magnetic pole portion 18 may alternatively be formed of three or more magnets with the same polarity.

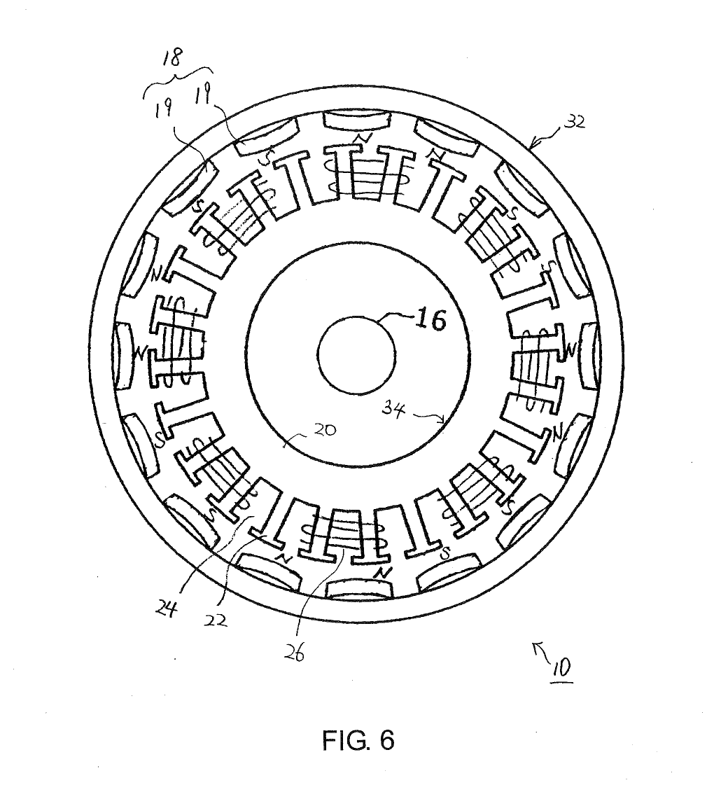

The two embodiments have been described with respect to a case where the power generator 10 is an inner-rotor power generator having the rotor 12 disposed inside the stator 14. The present invention, however, is not limited to this arrangement. The power generator 10 may be an outer-rotor power generator, such as shown in FIG. 6, having a rotor disposed outside a stator.

FIG. 6 is a diagram showing the arrangement of a power generator 10 according to still another embodiment. This power generator 10 is an outer-rotor power generator having a rotor 32 disposed outside a stator 34.

In the rotor 32, eight magnetic pole portions 18 are arranged at the inner peripheral side so as to alternately have different polarities in a circumferential direction. Each magnetic pole portion 18 is formed of a pair of permanent magnets 19 with the same polarity. Accordingly, in the rotor 32, sixteen permanent magnets 19 are arranged in order of N, N, S, S, N, N, S, S . . . .

The stator 34 is a hollow member in cylindrical form through which an input shaft 16 can extend. The stator 34 is concentric with the input shaft 16. The stator 34 has an annular yoke 20 and teeth 22 projecting radially outwardly from the outer periphery of the yoke 20 and disposed at predetermined intervals in the circumferential direction. In the present embodiment, twenty-four teeth 22 are disposed in the circumferential direction, as shown in FIG. 6. This number of teeth 22 is only an example. A slot 24, which is a space in channel form, is formed between each adjacent pair of the teeth 22.

Eight stator coils 26 are disposed at equal intervals in the circumferential direction. The stator coils 26 are continuously wound around adjacent pairs of the teeth 22, and one of the teeth 22 around which no stator coil 26 is wound exists between each adjacent pair of the stator coils 26.

The power generator 10 thus constructed can also obtain an increased output in comparison with the conventional power generator, as can those in the two embodiments described above. As described, teeth 22 with no windings are provided; in other words, the number of stator coils 26 is reduced relative to the number of teeth 22, thereby facilitating the operation to attach the stator coils 26 to the teeth 22.

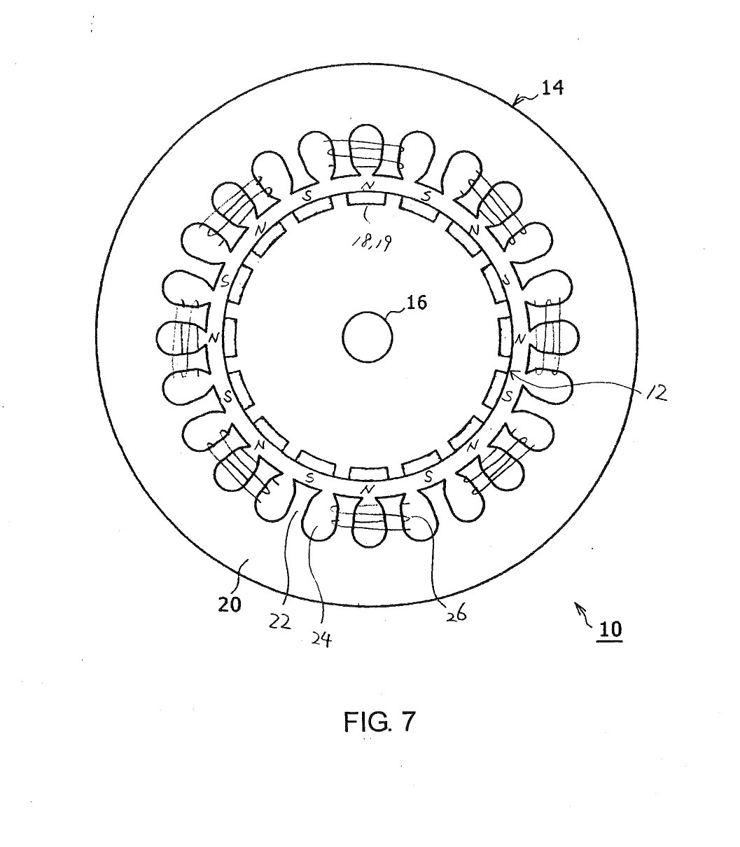

The embodiments have been described with respect to a case where the stator coils 26 in the same number as the magnetic pole portions 18 are disposed at equal intervals in the circumferential direction; that is, the number of magnetic pole portions 18 is m when the number of stator coils 26 is m. The present invention, however, is not limited to this arrangement. If the electric power of a single-phase alternating current is generated, the number of magnetic pole portions 18 can be set to 2·m when the number of stator coils 26 is m. This aspect will be described with reference to FIG. 7.

Referring to FIG. 7, as in the above-described embodiments, twenty-four teeth 22 are disposed in the circumferential direction; eight stator coils 26 are disposed in the circumferential direction at equal intervals by being continuously wound around adjacent pairs of the teeth 22; and sixteen permanent magnets 19, which are magnetic pole portions 18, are arranged on the rotor 12 so as to alternately have different polarities in the circumferential direction. With this arrangement, all the voltage waveforms output from the stator coils 26 are made identical with each other and the electric power of a single-phase alternating current can easily be extracted. Also in this embodiment, each magnetic pole portion 18 may be formed of a pair of permanent magnets 19 with the same polarity to obtain a further increased output.

The embodiments have been described with respect to a case where each stator coil 26 is wound around two adjacent teeth 22. The present invention, however, is not limited to this arrangement. Each stator coil 26 may be wound around three adjacent teeth 22. In this arrangement, if the number of stator coils 26 is m, the number of teeth 22 is 4·m. Provision of one tooth 22 around which no stator coil 26 is wound between each adjacent pair of the stator coils 26 is enabled thereby. For generation of the electric power of a single-phase alternating current, the number of magnetic pole portions 18 is m or 2·m.

The results of an experiment conducted by the inventor show that each of the above-described power generators 10 had the rotational speed of the rotor 12 increased and was able to obtain an increased output in comparison with the conventional three-phase alternating current power generator. In particular, it was possible to obtain a markedly increased output by setting the number of teeth 22 to any of 48, 36, 72 and 96. On the other hand, in the power generator 10, the conductor used for the stator coils 26 is largely reduced in comparison with the conventional three-phase alternating current power generator, thus achieving a material saving effect.

Each embodiment has been described with respect to a case where the magnetic pole portions 18 arranged on the rotor 12 are permanent magnets 19. The present invention, however, is not limited to this arrangement. The magnetic pole portions 18 may alternatively be electromagnet portions. Also, magnetic pole portions can be formed by winding rotor coils.

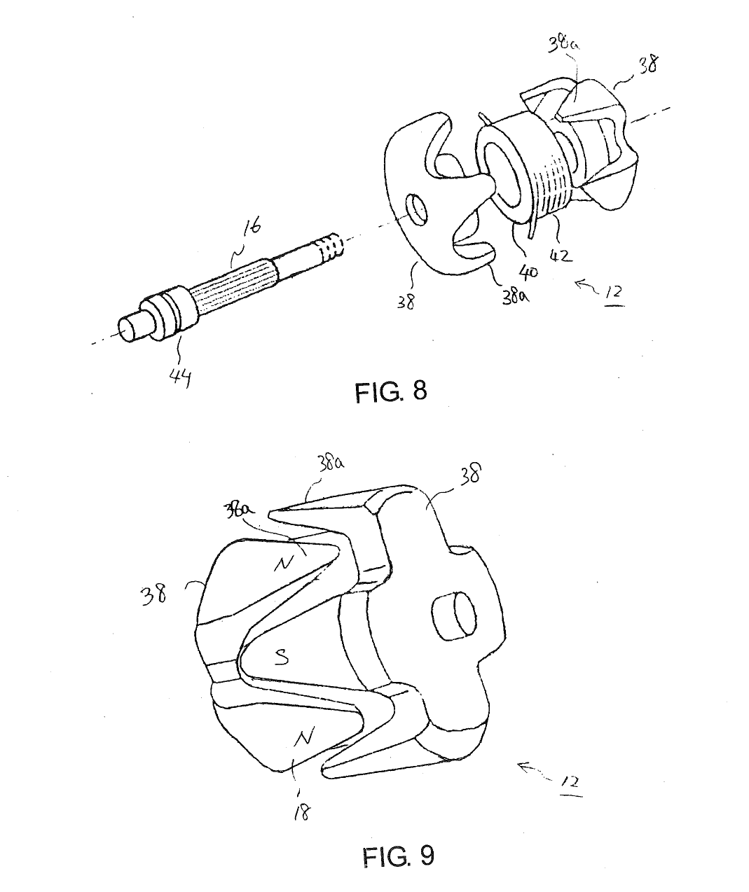

An example of the arrangement of a rotor 12 having electromagnets will be described with reference to FIGS. 8 and 9. FIG. 8 is an exploded perspective view of a rotor 12 having an electromagnet. FIG. 9 is a perspective view of the rotor 12 having an electromagnet.

The rotor 12 in this embodiment is a Lundell rotor in which two pole cores 38 are fixed by being fitted to each other through a bobbin 40 by press fit. Distal end portions 38a of the pole cores 38 in the axial direction have a nail-like shape. The number of distal end portions 38a corresponds to the number of poles. In the present embodiment, each pole core 38 has four distal end portions 38a. Accordingly, the number of poles is eight. The number of distal end portions 38a; i.e., the number of poles, can be set freely.

A rotor coil 42 is wound around the bobbin 40. A slip ring 44 provided on the input shaft 16 is electrically connected to the rotor coil 42. When the rotor coil 42 is energized with a current, the two pole cores 38 can have magnetic poles. More specifically, as shown in FIG. 8, N magnetic poles are formed at the distal end portions 38a of one of the pole cores 38 and S magnetic poles are formed at the distal end portions 38a of the other of the pole cores 38, thus forming in the rotor 12 an electromagnet alternately having different polarities.

In such a Lundell rotor, the magnetic pole portions 18 can be formed by an electromagnet. The embodiment shown in FIG. 9 has been described with respect to a case where one magnetic pole portion 18 is one of distal end portions 38a with one polarity, and where the distal end portions 38a are disposed at equal intervals so that N-poles and S-poles are alternately provided in the circumferential direction. The present invention, however, is not limited to this arrangement. One magnetic pole portion 18 may alternatively be a pair of distal end portions 38a with the same polarity, and such distal end portions 38a may be arranged by being spaced apart from each other in the circumferential direction. That is, electromagnets can be arranged in order of N, N, S, S, N, N, S, S . . . .

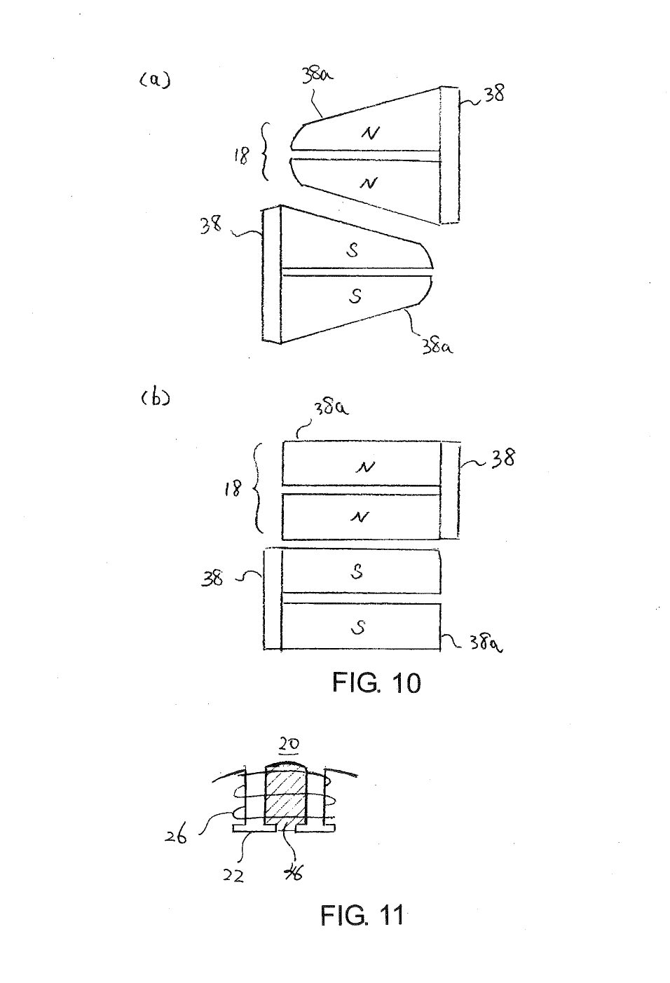

FIG. 10 shows examples of the shape of the distal end portions 38a of the pole cores 38. Referring to (a), distal end portions 38a in nail form similar to those shown in FIGS. 8 and 9 are formed in such a way as to be split into two. In such an arrangement, distal end portions 38a with the same polarities can be arranged in the circumferential direction by being spaced apart from each other. Referring to (b), distal end portions 38a have a rectangular shape and are formed in such a way as to be split into two. Also in such an arrangement, the distal end portions 38a with the same polarity can be arranged in the circumferential direction by being spaced apart from each other.

The embodiments have been described with respect to an arrangement in which stator coils 26 are wound around adjacent ones of teeth 22. In this arrangement, leaving one intermediate slot 24, a stator coil 26 is formed by being passed through slots 24 positioned on opposite sides of the one slot 24. According to the present invention, the adjacent teeth 22 may be formed into one integral body by removing the vacant slot 24 in the stator coil 26. Also, an auxiliary projecting pole 46 having a magnetic property may be provided in the vacant slot 24 in the stator coil 26, as shown in FIG. 11. The magnetic path wound around the stator coil 26 is expanded thereby. The auxiliary projecting pole 46 may be formed of the same material as that of the teeth 22. This arrangement entails degradation in output characteristics in comparison with the power generator 10 without the auxiliary projecting pole 46, but enables obtaining an improved output in comparison with the conventional power generators.

Further, according to the present invention, the teeth with no windings between the teeth around which the stator coils 26 are wound can be removed at the time of designing of the stator.

### REFERENCE SIGNS LIST

10 Large output, high efficiency, single phase, multi-polar power generator
12, 32 Rotor
14, 34 Stator
16 Input shaft
18 Magnetic pole portion
19 Permanent magnet
20 Yoke
22 Teeth
24 Slot
26 Stator coil
28 Current summation circuit
30 Voltage summation circuit
38 Pole core
40 Bobbin
42 Rotor coil
44 Slip ring

1. A large output, high efficiency, single phase, multi-polar power generator comprising:
a rotor having m or 2·m (m: an even integer not smaller than 2) magnetic pole portions arranged so as to alternately have different polarities in a circumferential direction; and
a stator having m·n (n: 3 or 4) teeth projecting in such a direction as to be opposed to the rotor, the teeth being formed at equal spaces in a circumferential direction,
wherein the stator has m stator coils wound around the teeth at equal intervals in a circumferential direction, and
wherein each of the stator coils is wound around adjacent n−1 ones of the teeth.

2. The large output, high efficiency, single phase, multi-polar power generator according to claim 1, wherein each magnetic pole portion is formed of a plurality of magnetic poles with the same polarity.

3. The large output, high efficiency, single phase, multi-polar power generator according to claim 1, wherein a circuit for generated power output from the stator coils is formed of a voltage summation circuit formed by series connection to obtain the sum of voltages or a current summation circuit formed by parallel connection to obtain the sum of currents.

4. The large output, high efficiency, single phase, multi-polar power generator according to claim 1, wherein a circuit for generated power output from the stator coils is formed of a combination of a voltage summation circuit formed by series connection to obtain the sum of voltages and a current summation circuit formed by parallel connection to obtain the sum of currents.

5. The large output, high efficiency, single phase, multi-polar power generator according to claim 1, wherein the teeth around which the stator coil is wound are formed into one integral body.
